(19) United States
(12) Patent Application Publication
(10) Pub. No.: US 2007/0183020 A1
(43) Pub. Date: Aug. 9, 2007

(54) Polarization independent phase modulator

(75) Inventor: Rifat Ata Mustafa Hikmet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/576,392

(22) PCT Filed: Oct. 11, 2004
(86) PCT No.: PCT/IB04/52043

§ 371 Date: Apr. 20, 2006

(30) Foreign Application Priority Data
Oct. 23, 2003 (EP) 03103936.5

(51) Int. Cl. G02F 1/01

(52) U.S. Cl. 359/279

(57) ABSTRACT

The present invention provides a polarization independent phase modulator for light comprising a layer of chiral liquid crystal mixture that has a low enough pitch to provide polarization independence of the effective refractive index for visible light. The liquid crystal mixture is controllable between a helix oriented ground state and a tilted state induced by the application of an electric field across the liquid crystal mixture layer. The liquid crystal mixture is preferably dispersed in a network material which ensures that the helix-oriented ground state is resumed when removing the electric field.

Liquid crystals (LC) are used in a wide range of applications, including full-color displays, temperature indicators, and switchable phase modulators such as gratings and lenses. Conventional liquid crystal cells selectively control polarized light, and are therefore typically stacked with polarizers. However, polarizers typically absorb more than 50% of the incident light and the resulting brightness is therefore affected.

Liquid-crystal phase modulators have a great potential for use as adaptive optics because of their light-transmitting operation, simple control, reliability, and low power consumption. In many applications the correction of low-order aberrations such as defocus and astigmatism is of primary importance.

Polymer dispersed liquid crystals (PDLC) have been suggested in order to provide polarization independent displays. In such displays the liquid crystal molecules are randomly oriented in a polymeric network giving rise to scattering of light. Application of an electric field induces uniaxial orientations of the molecules in the direction of the applied electric field. The refractive index of the polymer and the ordinary refractive index of the liquid crystal are matched so that light propagating in the direction of the applied field does not experience any refractive index changes and is therefore not scattered.

However, in optical devices such as switchable lenses and diffraction gratings where polarization independent switching is required, the PDLC effect cannot be used since it gives rise to undesirable light scattering. In order to reduce this problem, PDLC with sub micron droplets have been suggested. However, the refractive index of such systems change only marginally upon application of an electric field due to the presence of a large percentage of polymer within the system.

The easiest way to obtain a liquid crystal phase modulator, such as a lens, is for example to replace the glass of a normal macro lens with liquid crystal. Thinner constructions have also been suggested where liquid crystal is placed over a surface relief hologram or where (micro-) lenses are immersed in nematic liquid crystal to obtain an electrically controllable focal length (see for example U.S. Pat. No. 6,014,197). Such structures can be made using photo-resist or photo-replication techniques on transparent electrodes such as indium tin oxide.

Other adaptive lenses are controlled by arrays of individual electrodes, approximating the wave front by step functions by means of the zonal correction principle. Good approximation to a continuous wave front profile in these modulators requires a large number of discrete control electrodes.

The use of patterned electrodes also facilitates the production of liquid crystal micro-lenses. Such cells are constructed using electrodes patterned with mutually aligned holes on both substrates such that fringing fields between the electrodes cause the liquid crystal molecules to orientate themselves into what is, optically, a lens structure. Using such electrodes, more complicated beam steering functions can be realized.

So-called modal addressing, which allows a continuous variation of the phase profile across a device, can also be used in LC wave front correctors and modal LC lenses. In this technique two electrode regions with different resistances are used. The control voltage is applied to a low resistance annular electrode around the active area of the lens. The voltage across the lens decreases radially towards the center of the lens, because of the potential divider that is formed by the high resistance control electrode and the capacitance of the LC layer, i.e. its impedance increases radially towards the lens center. This means that the voltage decreases radially towards the center. Conversely, the optical path length of the LC layer increases from the periphery to the aperture center.

Another possibility is to irradiate the cell using a photo mask. In that case, monomer in the zones cured with a higher UV intensity lead to higher polymer network concentration. Conversely, the zones with a weaker UV exposure result in lower polymer network concentration. When a uniform voltage is applied, areas with lower concentration will switch while the other areas do not change their orientation, and in this way retardation variation is obtained across the cell.

However, almost all phase modulators described in the literature use uniaxially aligned nematics, which work for one polarization direction only. Operation with unpolarized light requires complicating measures to be taken, such as the use of two identical lenses having mutually orthogonal orientations. To this end, the purpose of the present invention is to provide phase modulators (wave retarders) that are polarization independent. Such elements can be used in optical units of various devices such as optical data storage systems (CD, DVD etc), in front of a luminaries used in lighting, optical interconnects, optical routing, printing and scanning, machine vision (pattern generation), optical computing, microscopy, auto focus and zoom functions in CCD cameras, and in pattern generators.

Thus, according to one aspect of the present invention a polarization independent phase modulator for light is provided. The phase modulator comprises two substrates and a layer of chiral liquid crystal mixture provided between said substrates. The chiral liquid crystal mixture is oriented in a helix oriented ground state, is controllable between said ground state and a tilted state by means of an electric field, has an effective refractive index which depends on the state of said liquid crystal mixture, and has a pitch that is sufficiently small to make the value of the effective refractive index substantially independent of the polarization of the light. The effective refractive index is the refractive index experienced by a light beam having a predetermined state of polarization. The light beam is preferably incident substantially in a direction perpendicular to the surface of the layer.

In the helix oriented ground state of the crystal mixture the directors of the liquid crystal molecules are oriented essentially parallel to the surface of the layer. The directors describe a helix having a long axis perpendicular to the surface. When an electric field is applied in a direction preferably perpendicular to the surface, a tilted state can be achieved. In the tilted state the directors of the molecules are oriented at an angle with respect to the surface of the layer, the direction of the long axis of the helix remaining unaltered. The tilt increases with increasing electric field. Light propagating in the direction of the long axis of the helix experiences an effective refractive index independent of the state of polarization of the light. The state includes both direction of polarization and mode of polarization such as linear or circular. In the tilted state of the crystal mixture light propagating in the direction of the long axis of the helix also experiences an effective refractive index independent of the state of polarization, but different from the effective refractive index experienced in the ground state.

The present invention thus provides an approach for polarization-independent phase switching of light using small pitch chiral liquid crystal mixtures that substantially do not reflect visible light. The effective refractive indices of the chiral liquid crystal mixture can be made switchable in a reversible and controllable way using in-situ polymerization resulting in a gel (e.g. non-reactive liquid crystal swollen by a polymer network). It is furthermore realized that the phase modulators can be electrically addressed to produce various optical effects which can be used for dynamic elements such as lenses, micro-lens arrays, deflectors, fan-out elements, beam profilers, beam steering, beam shapers, wave-front correctors.

Chirality or handedness is a property of molecules that are not symmetrical. Chiral molecules have a unique three-dimensional shape and as a result a chiral molecule and its mirror image are not completely identical.

A chiral nematic liquid crystal phase is obtained when a liquid crystal mixture showing the nematic phase is doped with chiral molecules. In the chiral phase, the long axis of the liquid crystal molecules (the director n) rotates about a helix. In this phase a wavelength band of incident circularly polarized light having the same sense of rotation as the helix is reflected while the band with the opposite sense is transmitted. The limits of the reflection band is however given as λₘₐₓ=p*nₑ and λₘᵢₙ=p*nₒ where p is the pitch corresponding to the length over which the directors rotates 360°, and nₑ and nₒ are the extraordinary and the ordinary refractive indices of an uniaxially oriented phase, respectively. The pitch is determined by the concentration of the chiral component and decreases with increasing chiral fraction. There are various chiral molecules described in the literature, which can be used for inducing a desired pitch in a nematic liquid crystal. The reflection provided for light in the reflection band is thus polarization dependent.

However, it is realized that polarization independent devices can be provided acting outside the reflection band. Thus, the use of liquid crystal mixtures with exceptionally low pitch, which would otherwise not be of interest, is found to provide excellent polarization independent transmissive phase modulators for visible light. In the context of the present invention, polarization independence is to be interpreted as essentially polarization independent for the state of polarization as well as for the direction of polarization. Thus, a phase modulator in accordance with the present invention provides an essentially polarization independent switchable phase shift. Any minor polarization dependences that might occur as marginal side effects do not affect the overall operation, and can thus be neglected from an operational point of view. As a measure for polarization dependence, the difference in the refractive indices experienced by two linearly polarized orthogonal beams of light traveling through the phase modulator can be used. In this context, one alternative is to use absolute numbers. In such case polarization independence for the purpose of the present invention requires the absolute refractive index difference to be below 0.10, and preferably even below 0.05. Alternatively the difference can be measured in relative numbers, in which case polarization independence for the purpose of the present invention requires the relative refractive index difference to be below 5%, and preferably below 2.5%.

As it turns out, a beam of light propagating in the direction parallel to the axis of the helix experiences a polarization independent refractive index which is roughly equal to (nₑ₊ₙₒ)/2. In other words a beam of plane polarized light propagating in the direction parallel to the axis of helix experiences the same refractive index of roughly (nₑ+nₒ)/2 for all polarization directions. Such a system can be described as uniaxial with a negative birefringence. When a sufficiently high electric field is applied in the direction of the helix (i.e. vertically across the layer of liquid crystal mixture), a uniaxial orientation can be induced among the liquid crystal molecules. Light traveling in the direction of the electric field in such a uniaxially oriented state experiences the polarization independent refractive index of nₒ.

In effect, the refractive index experienced by a beam of light propagating through the layer can be switched independent of the direction of its polarization, by applying an electrical field across the layer changing the orientation of the molecules. The electrical field is advantageously applied between two or more electrodes, provided at opposite sides of the layer of liquid crystal.

Thus, according to one embodiment, the phase modulator is operative (i.e. polarization independent) for light having a wavelength longer than a predetermined wavelength λ, and the pitch is smaller than λ/n, where n is the larger of the extraordinary refractive index and the ordinary refractive index of the liquid crystal mixture in a uniaxially oriented phase. For most liquid crystal mixtures the extraordinary refractive index is larger than the ordinary refractive index. The predetermined wavelength λ can, for example, be set so that the phase modulator is operative for the entire spectrum of visible light (e.g. λ=400 nm or even λ=350 nm).

In typical liquid crystal mixtures, the extraordinary refractive indices of the uniaxially oriented phase nₑ is somewhere between 1.3 and 1.7. Thus, a pitch in the magnitude of 250 nm gives a λₘₐₓ of approximately 375 nm (250 nm*1.5) for a material with a nₑ,of 1.5. Hence, according to one embodiment of the invention, the pitch is smaller than 250 nm. Such phase modulators are operable for the entire visual spectrum of wavelengths. However, larger pitches are envisaged as well, e.g. 350 nm, giving a threshold wavelength of about 525 nm (350 nm*1.5=525 nm) depending on the refractive index at hand. Such modulators are polarization independent only for a part of the visual spectrum of wavelengths (e.g. the part larger than 525 nm); this might however be sufficient for some applications. According to one embodiment, and as indicated above, the pitch is sufficiently small to provide for polarization independence for the entire spectrum of visible light, i.e. for light having a wavelength (i.e. λ) larger than 400 nm or even larger than 350 nm. Thereby, the entire visible light spectrum is included in the polarization independent operational wavelength range. This is highly desirable for a large number of applications.

In order to obtain fast and reversible switching a memory state needs to be built into such a chiral system. Furthermore, in order to obtain gradual, polarization independent switching for a beam of light propagating in the direction perpendicular to the cell surfaces, a conical deformation mode where the molecules start tilting in the direction of the applied voltage is needed. This can be achieved by creating a lightly cross-linked network dispersed within the non-reactive liquid crystal molecules. Thus, according to one embodiment, the chiral liquid crystal mixture comprises liquid crystal molecules which are dispersed in a network material.

The network material can, for example, be an anisotropic polymer network provided by in-situ polymerization in the presence of the non-reactive chiral liquid crystal molecules. In order to obtain controllable and reversible switching of the molecules the liquid crystal mixture has preferably an adequately high polymer network density that is sufficiently cross-linked. Ideally the concentration of the cross-linking molecules in the mixture is higher than 0.5 percent by weight and the molecules that form the linear polymer chain (which are cross-linked) have a concentration exceeding 20 percent by weight. However, according to one more general embodiment, the liquid crystal mixture comprises 10-60 percent by weight molecules forming linear parts of the polymer chain which are linked by 0.5-1 percent by weight cross-linking molecules which provides cross-linking between the linear parts of the polymer chain.

The phase modulator according to the present invention can be designed with various controllable optical properties. For example, it can operate as a focusing lens or as a grating depending on lateral variations in the tilt angle of the liquid crystal molecules. The laterally varying tilt angles result in correspondingly varying refractive indices in the liquid crystal mixture. Such variations can be provided in different ways.

For example, according to one embodiment the polymer network material has a laterally varying concentration such that lateral variations of said tilted state and thus of said polarization independent effective refractive index are provided upon application of an uniform electric field across the layer of liquid crystal mixture. The variations in the network material can be such that the tilted state is locally hampered in areas with increased polymer network concentration when exposing the liquid crystal molecules for an electric field. The variations can be provided, for example, by means of a photo-polymerization process using a photo mask. This embodiment is advantageous since a varying or structured refractive index can be provided using a homogenous electric field. In effect, the refractive index of areas where molecule movements are hampered will remain essentially the same as in the helix oriented ground state (i.e. the average of the ordinary and the extraordinary refractive indices). In case polymer network concentration variations are present, the concentration values specified above might only apply to regions with higher polymer network concentrations.

Alternatively, structured refractive indices can be provided by a varying electric field, only setting certain regions of the liquid crystal layer in a tilted state. Thus according to one embodiment, at least one of the substrates is provided with a structured electrode, which is operative to apply a laterally varying electric field across said layer of liquid crystal mixture, and which thus provides for lateral variations in said tilted state and which as a consequence provides for lateral variations in said polarization independent refractive index

However, laterally varying optical properties do not have to originate from varying refractive indices in the liquid crystal mixture. Another alternative is to put a static lens structure inside the liquid crystal matrix.

Thus, according one embodiment, the light modulator further comprises an optically static structure arranged between said substrates and having a refractive index that is different from the effective refractive index of the liquid crystal mixture in at least one of the liquid crystal mixture states. Thereby a light modulating property is provided by an interface between said static structure and said layer of liquid crystal mixture. The optically static structure can, for example, have the shape of a lens and in such case it defines a convex interface with the liquid crystal mixture.

According to one embodiment, the optically static structure has the same refractive index as the effective refractive index of the liquid crystal mixture in ground state. Thereby the structure is optically invisible in the ground state. However, applying an electric field across the liquid crystal mixture will alter the effective refractive index of the liquid crystal mixture and will thus provide an interface between regions with different refractive indices. In case the structure is lens-shaped, the interface thereby provides a light focusing (or defocusing) effect. However, it is also possible to use other static structures as well, for example a system of elongated prisms providing a grating effect.

Phase modulators according to the present invention can be implemented in a variety of optical devices. For example, according to one aspect of the invention, a switchable lens comprising an inventive phase modulator is provided. According to one embodiment, the phase modulator in the inventive switchable lens further comprises circular symmetric electrodes which are arranged on said substrates and which are operative to apply a circular symmetric electric field across the layer of liquid crystal mixture. Thereby circular symmetric refractive properties are provided for the inventive lens. In such a configuration the thickness of the element can be significantly reduced compared with prior art.

According to another aspect of the invention, a switchable grating comprising an inventive phase modulator is provided. Such a switchable grating can selectively diffract light of a certain wavelength and can for example be used in optical recorders using two light beams of different wavelengths.

According to still another aspect of the invention, a light source comprising an inventive phase modulator is provided. The phase modulator in the inventive light source is thereby operative to control the shape and/or the direction of the light emitted from said light source.

According to still another aspect of the present invention, an optical data storage system having an optical path and comprising an inventive phase modulator arranged along said optical path is provided. Such a modulator can be used to alter the position of the focus of a light beam dynamically and also to compensate various optical aberrations occurring during the scanning of an optical record carrier. An example of the aberration correction is the correction for the differences in layer thickness of various types of record carriers that need to be read using the same optical path. According to one embodiment, the data storage system is a Compact Disc system, a Digital Video Disc system or a Blu-ray system.

Further features and objects of the present invention will be appreciated when the following detailed description of some preferred embodiments thereof is read and understood. In the following description, reference is made to the accompanying drawings, in which:

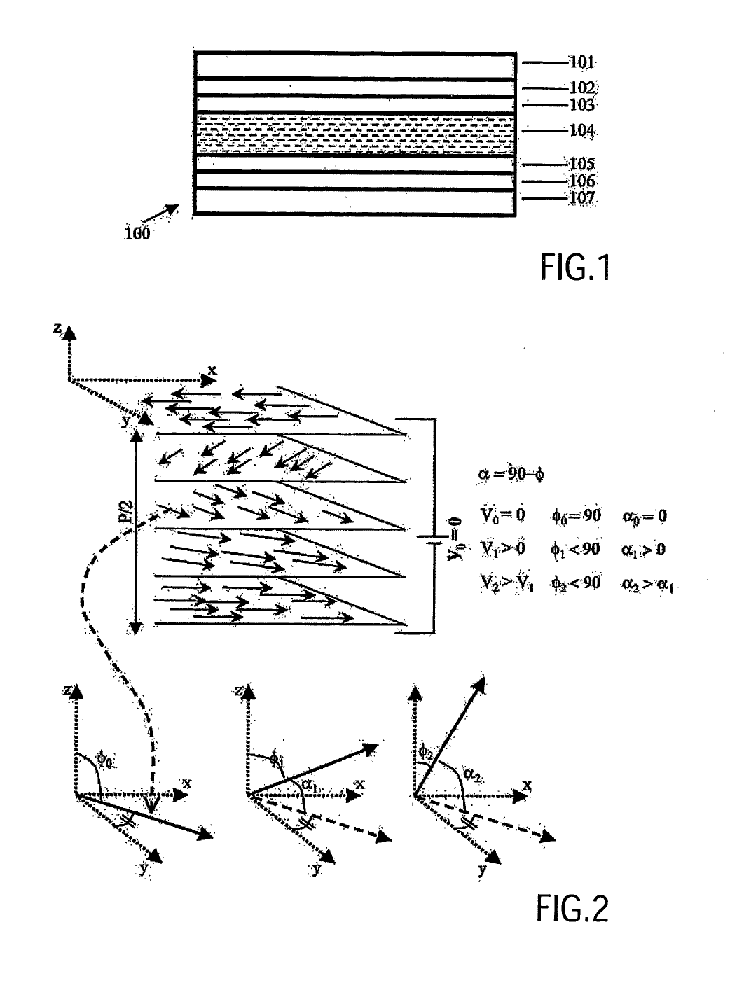

FIG. 1 is a schematic cross-section of a polarization independent phase modulator.

FIG. 2 illustrates the helix orientation in the liquid crystal mixture, and defines some spatial angles in the mixture.

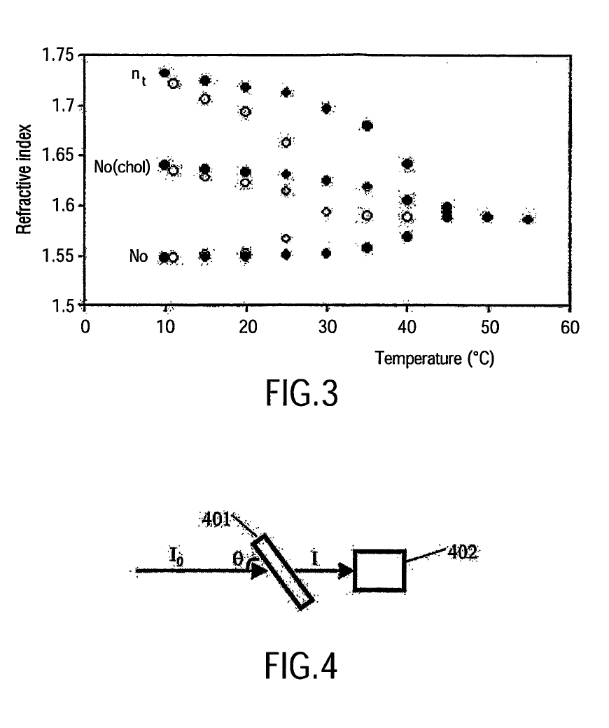

FIG. 3 is a diagram illustrating the refractive index as a function of temperature in a liquid crystal mixture.

FIG. 4 illustrates an experimental set-up for measuring light intensities at different angles.

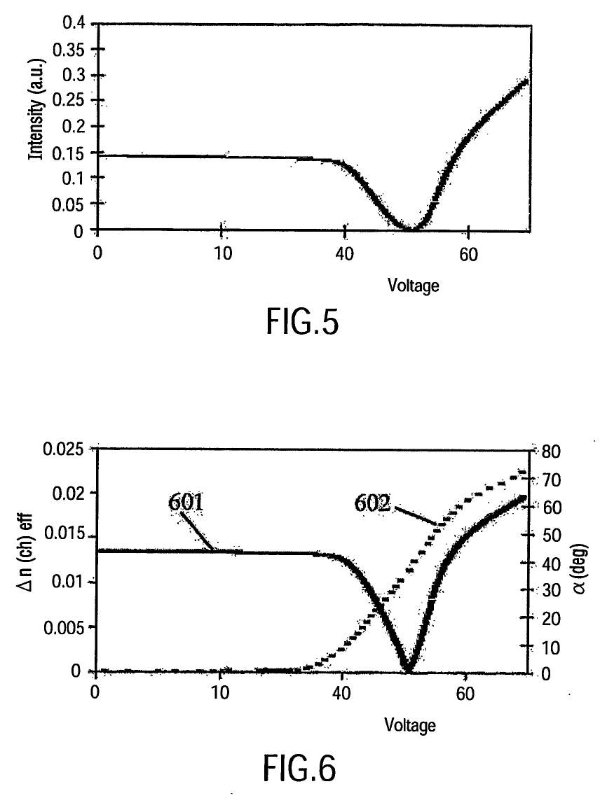

FIG. 5 is a diagram illustrating the transmitted intensity as a function of applied voltage.

FIG. 6 illustrates the effective birefringence and the tilt angle as a function of applied voltage.

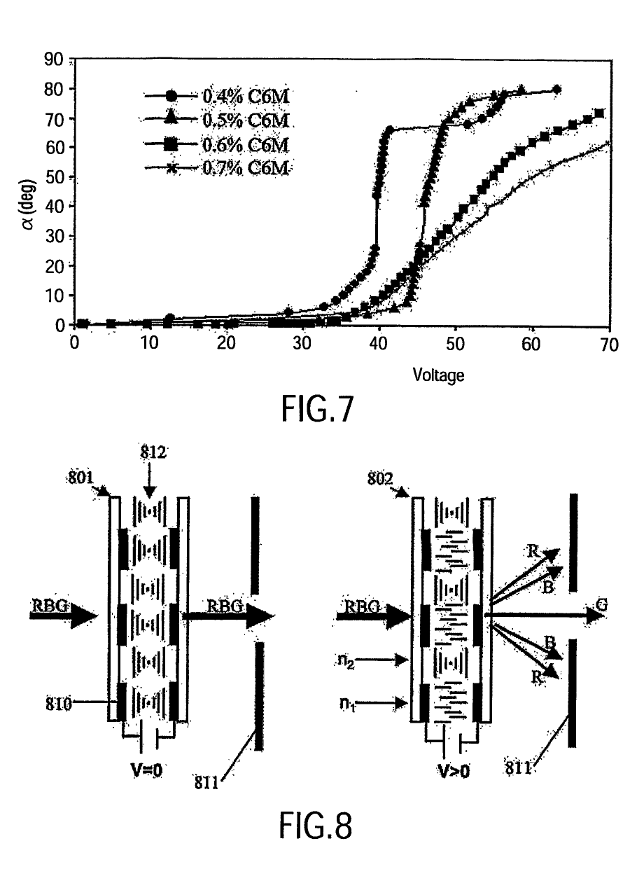

FIG. 7 illustrates the tilt angle as a function of voltage for different liquid crystal mixtures.

FIG. 8 schematically shows cross-sections of an inventive phase modulator when a voltage is applied and when no voltage is applied.

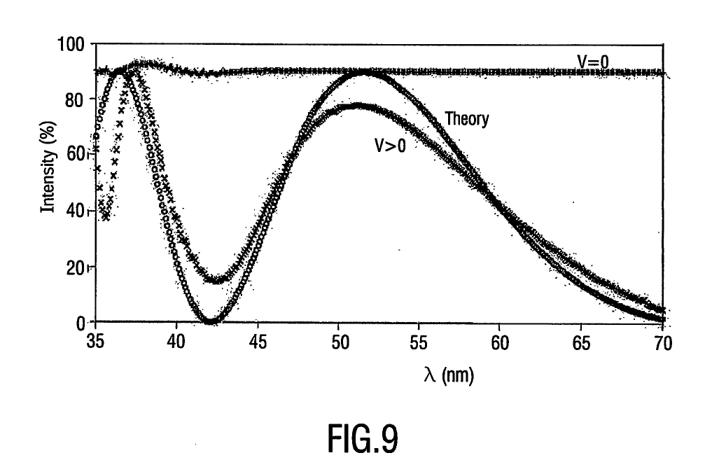

FIG. 9 is a diagram illustrating the transmitted intensity as a function of wavelength when no voltage is applied and theoretical as well as actual intensities when a voltage is applied.

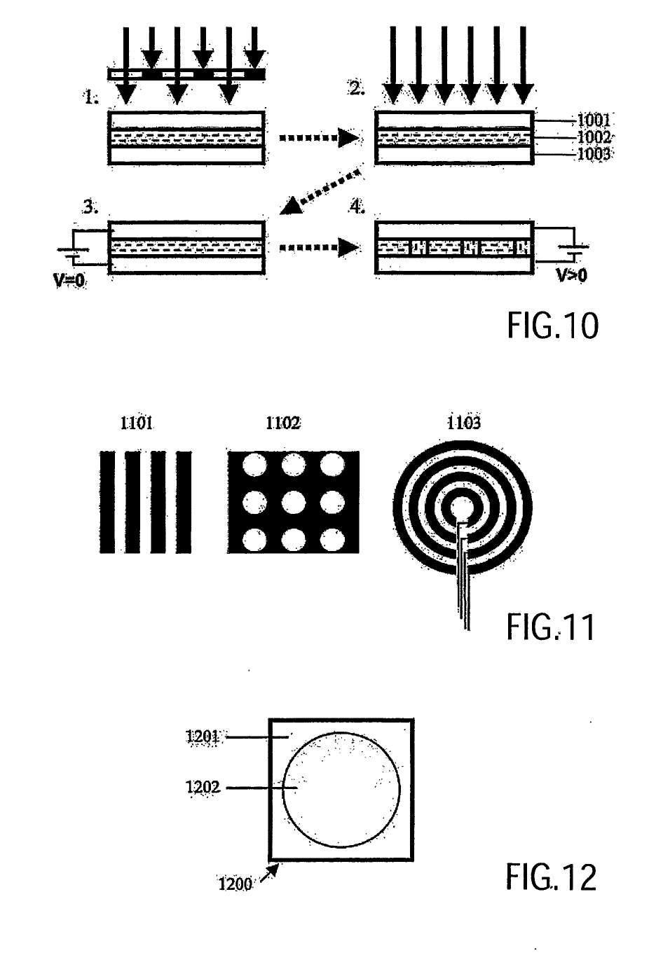

FIG. 10 illustrates cross-sections of inventive phase modulators during manufacturing and subsequent use.

FIGS. 11 and 12 shows different electrode designs for embodiments of the present invention.

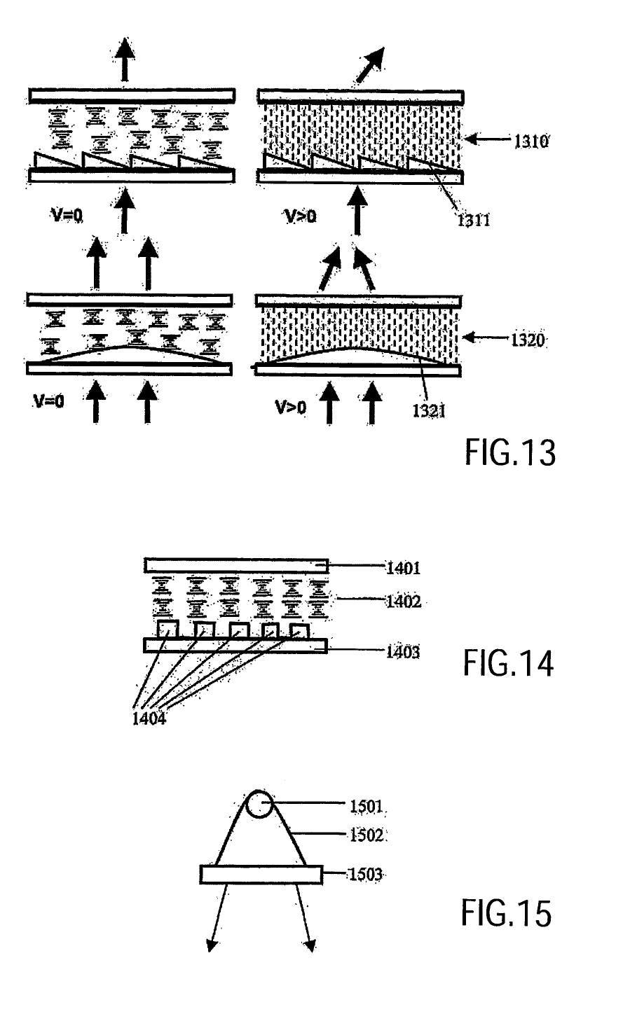

FIGS. 13 and 14 shows cross-section of different embodiments that has a static structure in the liquid crystal mixture layer.

FIGS. 15 to 19 schematically illustrate different implementations of the inventive phase modulator.

A general design of a liquid crystal cell 100 is shown in FIG. 1. The cell comprises substrates 101, 107, transparent electrodes 102, 106, and orientation layers 103, 105. A layer 104 of liquid crystal mixture is sandwiched between the orientation layers. The electrodes 102, 106 are operative to apply an electric field across the liquid crystal layer 104, thereby reorienting the liquid crystal molecules from a helix oriented state to a tilted state. In the cell according to the invention, the liquid crystal is dispersed in a polymer network that provides for a stable memory state such that the orientation of the liquid crystal molecules always returns to their helix-orientated ground state when the electric field is removed.

Definitions of various coordinates in the cell are given in FIG. 2. FIG. 2 schematically shows five layers of phase modulators according to the invention that have different molecular orientations along the helix at a distance of half a pitch (P/2), when no electrical field is applied (V₀=0). As can be seen, the molecules can be defined as uniaxially aligned in parallel (i.e. lateral) layers which are stacked on top of each other and wherein the mean orientation direction of the molecules in the respective layers rotate about a helix turning 180°. The vertical distance for turning 360° would of course equal the pitch.

Also shown in FIG. 2 are three schematic tilt orientations, Φ₀, Φ₁, and Φ₂ corresponding to voltages V₀=0, V₁>V₀, and V₂>V₁, respectively. As can be seen, the angular molecule orientation within the cell plane is independent of any applied electrical field, while the angular molecule orientation in relation to the cell plane (the tilt angle α) increases with increased field strength.

The liquid crystal mixture is doped with chiral molecules which provide the helix orientation. In order to be transparent to visible light, the pitch must be sufficiently small.

According to one example, the liquid crystal mixture contains 20% chiral monoacrylate CBC which form the main polymer chain upon polymerization, 45% non-reactive chiral dopant CB15, 35% non-reactive liquid crystal BL59 (obtained from Merck, Darmstadt), 0.5% Irgacure 651 (obtained from Ciba Geigy), and various concentrations of diacrylate C6M which form the cross-links upon polymerization and photo initiators were produced. Below the structures of the reactive molecules which can be polymerized are shown together with the structure of CB15 and the photo initiator.

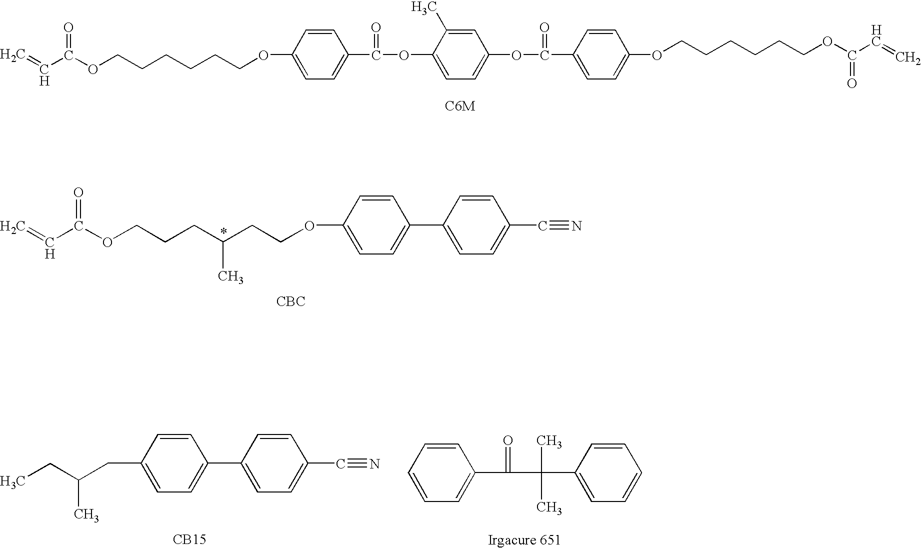

For experimental purposes the mixtures were placed in cells like the one shown in FIG. 1 containing Indium Tin Oxide (ITO) electrodes and covered with polyimide layers buffed with velvet cloth. The cell gap was set to 4 μm using glass spacers between the substrates. In FIG. 3 refractive indices of the uniaxial nematic phase is plotted as a function of temperature for the mixture before and after polymerization. In the present work the pitch was determined using the relation P=λₘₐₓ/nₑ, after measuring the reflection band maximum λₘₐₓ using a spectrometer and the extraordinary refractive nₑ index using a refractometer for liquid crystal mixtures containing various fractions of chiral molecules. The pitch was plotted as a function of concentration of the chiral component and the pitch of the mixture is extrapolated to be around 200 nm. There are also other ways of measuring the pitch, for example using X-ray diffraction or electron microscopy. Another conventional way of estimating the pitch is to use a wedge cell whereby it is possible to estimate the pitch of the chiral material from the wedge angle and the position of the so-called disclination lines. It can be seen from FIG. 3 that the isotropic transition temperature and the extraordinary refractive index of the material increases upon polymerization (black dots correspond to a polymerized mixture and white dots correspond to a non-polymerized mixture). As described above the pitch of the mixture is about 200 nm and the extraordinary refractive index nₑ of the mixture after polymerization is about 1.74 as can be seen in FIG. 3. This gives λₘₐₓ=348 nm (1.74*200) indicating that this material is suitable for the entire visible range of wavelengths and also for longer wavelengths.

A layer of chiral liquid crystal mixture with such a small pitch has negative birefringence. Therefore, when a cell containing such a layer is placed between crossed polarizers so that the incident beam of light is perpendicular to the plane of the cell, the polarization direction is not altered and therefore the cell appears dark. In effect, the cell is polarization independent for light impinging perpendicular to the cell.

Birefringence appears for this incident beam only when the cell is placed at an angle. In order to further study the characteristics of the inventive cell, sample cells were put at an angle of θ=45° with respect to the beam of light. This is schematically illustrated in FIG. 4, which shows a light ray with intensity I₀ incident at an angle θ into a liquid crystal cell 401 according to the invention. The transmitted light intensity I is measured by a photodetector 402.

Experiments have been conducted using light with a wavelength of 550 nm. FIG. 5 shows the intensity of light passing through the cell as a function of voltage. It can be seen that with increasing voltage the intensity goes through a minimum before it increases. This behavior can be explained by a change in the effective birefringence with increasing voltage. The effective birefringence (Δn_{eff}) is related to the transmitted intensity I as

$$I = {I}_{0} {sin}^{2} ( \frac{π d Δ {n}_{eff}}{λ} ) \qquad ( 1 )$$

where I₀ is the maximum transmitted intensity when the polarizer and the analyzer are set to be parallel to each other, d is path length of the light beam in the liquid crystal layer and λ is the wavelength of the monochromic light.

Using the data from FIG. 5 and equation (1), Δn(ch)_{eff} is plotted as a function of voltage and the results are shown in FIG. 6 (the solid line 601, referring to the left ordinate axis). It can be seen that the effective birefringence decreases to become zero at around 50 volt, before reaching a saturation value at higher voltages. The continuous change of birefringence is related to the conical deformation where the chiral helix and the pitch stays intact while the liquid crystal molecules start tilting towards the applied field. Eventually all molecules are oriented in the direction of the applied field. In the coordinates shown in FIG. 2 this corresponds to an increase in a with increasing voltage. The extraordinary refractive index nₑ(ch) and the ordinary refractive index nₒ(ch) in the chiral phase are related to the extraordinary refractive index nₑ and the ordinary refractive index nₒ of the uniaxial nematic phase and the tilt angle α of the molecules as

$$\begin{matrix}{n}_{o} ( ch ) = \frac{{n}_{o} {n}_{e} + {n}_{o} {\{ {n}_{o}^{2} {cos}^{2} ( α ) + {n}_{e}^{2} {sin}^{2} ( θ ) \}}^{1 / 2}}{2 {\{ {n}_{o}^{2} {cos}^{2} ( α ) + {n}_{e}^{2} {sin}^{2} ( α ) \}}^{1 / 2}} & ( 2 ) \\ {n}_{e} ( ch ) = \frac{{n}_{o} {n}_{e}}{{\{ {n}_{e}^{2} {cos}^{2} ( α ) + {n}_{o}^{2} {sin}^{2} ( α ) \}}^{1 / 2}} . & ( 3 )\end{matrix}$$

The effective ordinary refractive index nₒ(ch)_{eff} of the chiral phase does not depend on the angle θ (the angle between the light beam and the surface of the cell containing the liquid crystal mixture)whereas the extraordinary index of the chiral phase nₑ (ch)_{eff} is related to the angle θ as

$${{n}_{e} ( ch )}_{eff} = \frac{{n}_{o} ( ch ) {n}_{e} ( ch )}{{\{ {[ {n}_{o} ( ch ) cos ( θ ) ]}^{2} + {[ {n}_{e} ( ch ) sin ( θ ) ]}^{2} \}}^{1 / 2}} \qquad ( 5 )$$

The effective birefringence Δn(ch)_{eff} of the chiral phase in turn is related to the angle θ as

$$Δ {n ( ch )}_{eff} = {n}_{o} ( ch ) - \frac{{n}_{o} ( ch ) {n}_{o} ( ch )}{{\{ {[ {n}_{o} ( ch ) cos ( θ ) ]}^{2} + {[ {n}_{e} ( ch ) sin ( θ ) ]}^{2} \}}^{1 / 2}} \qquad ( 5 )$$

Using equations 2, 3, and 5 the tilt angle α was estimated from the effective birefringence and plotted as a function of voltage in FIG. 6. It can be seen that above a critical voltage conical deformations are induced and the tilt angle a increases continuously with increasing voltage (the dotted line 602, referring to the right ordinate axis).

Here it is important to note that the switching behavior shown by the gel is totally reversible and the molecules revert to their initial state of orientation upon removal of the applied voltage. In these gels the presence of the small concentration of the cross-links (C6M) preserves the chiral order during the tilting of the liquid crystal molecules. The effect of the cross-link concentration on the switching process was therefore studied. In FIG. 7 the tilt angle α is plotted as a function of voltage for gels containing various concentrations of cross-linker C6M. It can be seen that for gels containing 0.4% and 0.5% C6M the tilt angle start increasing gradually already at low voltages. Above a critical voltage a sharp increase in the tilt angle is followed again by a modest increase as the tilt angle a tends to become 90°. Gels containing higher concentrations (0.6% and 0.7%) of C6M however show a slightly different behavior. At low voltages the tilt angle remains unaltered until a threshold voltage is reached above which the tilt angle starts increasing continuously with increasing voltage. When gels containing 0.6% and 0.7% C6M are compared it can be seen that the gel with a higher cross-link density shows a lower slope.

A straightforward way of providing a grating functionality in a cell according to the invention is to arrange striped electrodes 810 as shown in FIG. 8. The effective grating period is thus a function of the space between the electrode stripes 810. When applying an electric voltage V between the electrodes on each side of the liquid crystal layer 812, the grating is activated and operates polarization independent for light with normal incidence. Using a small pitch mixture in the configuration shown in FIG. 8 the intensity was measured through an aperture 811 as a function of wavelength for unpolarized light before 801 and after 802 applying a voltage and the result is shown in FIG. 9.

In FIG. 9 there is also a curve showing the theoretically expected behavior for the beam which is not blocked by the aperture 811 as a function of wavelength where two isotropic indices are assumed for the two regions (n₁ and n₂, respectively) in equation 5. The refractive indices n₁ and n₂ correspond to the regions of the grating where the molecules are either in the ground or tilted states respectively.

$$I = {I}_{0} cos ( \frac{π d ( {n}_{1} - {n}_{2} )}{λ} ) \qquad ( 6 )$$

Phase modulators according to the present invention can be produced using different methods. One of the methods involves irradiation of the gel through a mask or holographic means. In this way a gel with locally varying structure and various threshold voltages could be created. Upon application of a voltage the structure built in the gel become visible in the form of refractive index variations as shown in FIG. 10. Providing such an element thus involves five conceptual steps:
0. Providing a liquid crystal mixture cell, comprising a liquid crystal mixture 1002 sandwiched between two transparent substrates 1001, 1003 provided with electrodes and orientation layers.
1. Radiating ultraviolet light through a suitable mask onto the liquid crystal mixture 1002, whereby the mixture is locally polymerized.
2. Radiating ultraviolet light homogenously onto the mixture 1002, whereby a certain level of polymerization is ensured in all regions of the mixture such that a stable memory state is provided.
3. Connecting a voltage supply to electrodes arranged parallel with each substrate.
4. Applying a voltage between the electrodes, thus creating a homogenous electric field across the liquid crystal mixture 1002. Regions with higher polymer network density will (i.e. that have received a higher exposure of ultraviolet light) will remain in the helix state, or at least not be as tilted as the regions with a lower polymer network density.

Of course, many different mask patterns can be used, resulting in various refractive index patterns when an electric field is applied.

Another way of obtaining a refractive index pattern is to use patterned electrodes. A few examples of such electrodes are shown in FIGS. 11 and 12. In FIG. 11, electrode 1101 provides a grating pattern, electrode 1102 provides a micro-lens array, and electrodes 1103 provides a lens with variable circular-symmetric refractive properties which for example can be used in a lens or a phase correcting element (depending on the voltage set-up on each individual electrode). FIG. 12 illustrates an electrode having a circular region 1202 that has a higher electrical resistance than its surroundings 1201. Applying a voltage to such an electrode in a cell according to the invention results in an electric field that gradually weakens towards the center of the cell, and thus provides for a correspondingly gradual change of refractive index.

Apart from polarization independent gratings, switchable lenses such as Fresnel and Gabor lenses or lens arrays can also be produced using the above approaches.

Furthermore, polarization insensitive geometrical optical components such as switchable lenses and gratings can also be produced by placing optically static objects in the liquid crystal cell as shown in FIGS. 13 and 14. The structures are preferably transparent and might, for example, have the same refractive index as the liquid crystal mixture in its ground state. Thereby the structures are optically inactive (no refractive index interface) unless the mixture is exposed to an electric field tilting the liquid crystal molecules and thus altering the refractive index of the mixture. The structures can be applied onto transparent surfaces using photo-replication or photo-embossing techniques.

The easiest way of replicating a desired structure is to use a mould provided with the desired structure. A liquid monomer with reactive groups is then squeezed between the substrate and the mould. Upon polymerization of the monomer the liquid vitrifies and the mould can then be removed leaving behind the replica layer (the layer with the desired surface structure) on top of the substrate.

In FIG. 13, two embodiments 1310, 1320 with different static structures are illustrated in the ground state (V=0) and in the tilted state (V>0). The structure in embodiment 1320 provides a convex refractive index interface 1321. The embodiment 1320 illustrates a single lens structure however it can also be a micro lens array that would work in the same way. The embodiment 1310 provides a prism array that leads to the bending of a beam of light in the tilted state. In FIG. 14 an embodiment is illustrated that has an array of ruled grating structures, providing for diffraction effects.

Independent from the chosen design (e.g. polymer network variations, structured electrodes, or the inclusion of optically static structures) the phase modulator according to the invention can be used for many different applications.

For example, FIG. 15 illustrates a lamp arrangement comprising a lamp 1501, a reflector 1502, and an inventive phase modulator for controlling the shape and/or the direction of the light beam. Using a phase modulator such as a switchable lens or lens array one can influence the shape of the beam while the array of prisms illustrated in FIG. 13 (1310) can be used for beam steering. For this application complex beam shapers can also be produced using patterned networks. In this way complex electrode structures can be avoided.

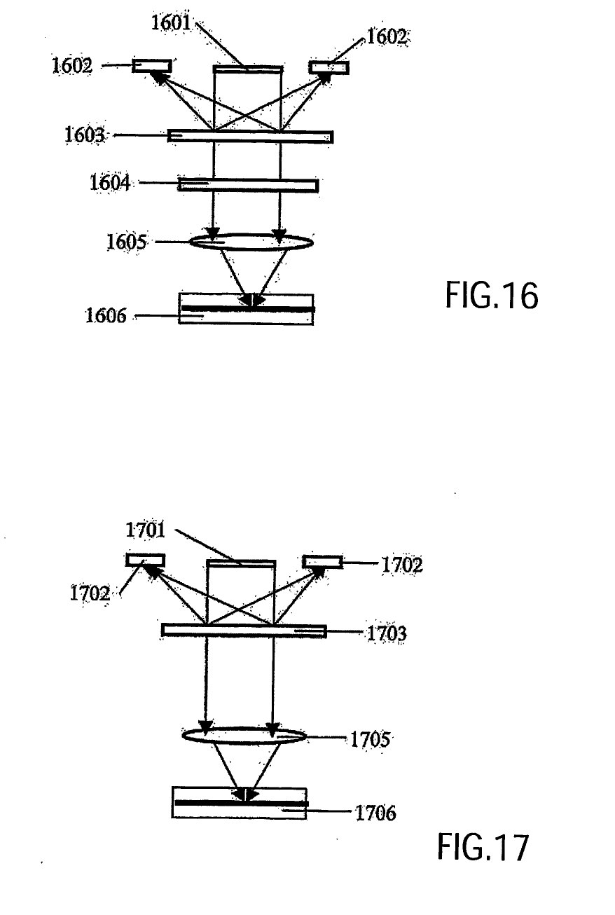

FIG. 16 illustrates a read unit for a Compact Disc (CD) or a Digital Video Disc (DVD) 1606, comprising a laser source 1601, diodes 1602, a grating 1603, an switchable wave front compensator or lens 1604 according to the invention, and a lens 1605. Such a wave front compensator can be used in order to correct for the aberrations taking place during the lifetime of the recorder but also aberrations caused by temperature variations. It can also correct for chromatic aberrations if more than one wavelength is used in the optical path of the unit. Furthermore, the wave front compensator can correct for the optical path variations in the disc caused by tilting during the rotation of the disc. In various discs the layer carrying the information is placed at various other distances with respect to the surface of the disc. Such a compensator according to the present invention can also take care of the optical path variations caused by the depth of the information in various discs.

FIG. 17 illustrates another read unit for CDs or DVDs 1706 comprising a laser source 1701, diodes 1702, a switchable grating 1703, and a static lens 1705. Such a grating can preferably be made using the technique described in FIG. 14, as its performance is highly demanding. Such a switchable grating again can be used in units using more than one wavelength in order to get maximum diffraction efficiency.

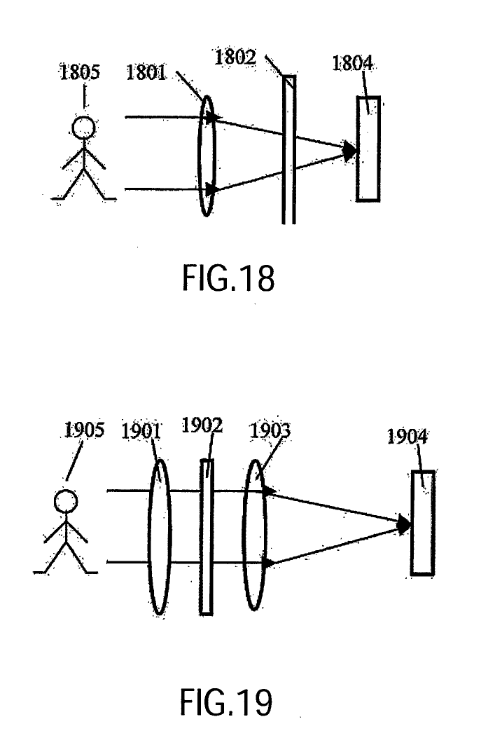

FIG. 18 illustrates a focus lens device for a CCD (Charge Coupled Device) camera for imaging an object 1805 onto the CCD detector 1804. The focus lens device comprises a static lens 1801 and a switchable lens 1802. FIG. 19 illustrates a switchable zoom lens device for a CCD camera for imaging an object 1905 onto the CCD detector 1904. The zoom lens device comprises a first static lens 1901, a switchable lens 1902 and a second static lens 1903. For example, lenses based on modal addressing shown in FIG. 12 are suitable for use in the applications described with reference to FIGS. 18 and 19.

In essence, the present invention provides a polarization independent phase modulator for light comprising a layer of chiral liquid crystal mixture that has a low enough pitch to provide polarization independence of the effective refractive index for visible light. The liquid crystal mixture is controllable between a helix oriented ground state and a tilted state induced by the application of an electric field across the liquid crystal mixture layer. The liquid crystal mixture is preferably dispersed in a network material which ensures that the helix-oriented ground state is resumed when removing the electric field.

1. A polarization independent phase modulator (100) for light, comprising:
two transparent substrates (101, 107); and
a layer (104) of chiral liquid crystal mixture, between said substrates;
wherein said chiral liquid crystal mixture is oriented in a helix oriented ground state;
is controllable between said ground state and a tilted state by means of an electric field;
has an effective refractive index which depends on the state of said liquid crystal mixture; and
has a pitch that is sufficiently small to make the value of the refractive index substantially independent of the polarization of the light.

2. A polarization independent phase modulator (100) according to claim 1 for light having a wavelength longer than a predetermined wavelength λ wherein said pitch is smaller than λ/n, n being the larger of the extraordinary refractive index and the ordinary refractive index of the liquid crystal mixture in a uniaxially oriented phase.

3. A polarization independent phase modulator (100) according to claim 2, wherein said predetermined wavelength λ is 400 nm or, preferably, 350 nm.

4. A polarization independent phase modulator (100) according to claim 1, wherein said pitch is smaller than 350 nm, and preferably smaller than 250 nm.

5. A polarization independent phase modulator (100) according to claim 1, wherein said chiral liquid crystal mixture comprises liquid crystal molecules which are dispersed in a network material.

6. A polarization independent phase modulator (100) according to claim 5, wherein said network material is a anisotropic polymer network and wherein said dispersed mixture consists of 10-60 percent by weight linear polymer molecules which are linked by 0.5-1 percent by weight cross-linking molecules.

7. A polarization independent phase modulator (100) according to claim 5, wherein said network material has a laterally varying concentration (1002) such that lateral variations of said tilted state and thus of said polarization independent refractive index is provided upon application of a uniform electric field across said layer of liquid crystal mixture.

8. A polarization independent phase modulator (100) according to claim 1, wherein at least one of said substrates (101, 107) is provided with a structured electrode (1101, 1102, 1103, 1200), which is operative to apply a laterally varying electric field across said liquid crystal molecules, thereby providing lateral variations in said tilted state and, as a consequence, lateral variations in said polarization independent refractive index.

9. A polarization independent phase modulator (100) according to claim 1, further comprising an optically static structure (1311, 1321, 1404) arranged between said substrates and having a refractive index that is different from the effective refractive index of the liquid crystal mixture in at least one of the liquid crystal mixture states, such that a light modulating property is provided by an interface between said static structure and said layer of liquid crystal mixture.

10. A switchable lens (1502, 1802) comprising a polarization independent phase modulator (100) according to claim 1.

11. A switchable lens (1502, 1802) according to claim 10, wherein said polarization independent phase modulator (100) further comprises circular symmetric electrodes (1103, 1200) arranged on said substrates (101, 107) and operative to apply a circular symmetric electric field across the layer (104) of liquid crystal mixture for inducing circular symmetric refractive properties of said lens.

12. A switchable grating (1703) comprising a polarization independent phase modulator (100) according to claim 1.

13. A light source (1501, 1502) comprising a polarization independent phase modulator (1503) according to claim 1, wherein said phase modulator is operative to control the shape or the direction of light emitted from said light source.

14. An optical data storage system (1601-1605; 1701-1705) having an optical path and comprising a polarization independent phase modulator (1604; 1703) according to claim 1 arranged along said optical path.

15. An optical data storage system (1601-1605; 1701-1705) according to claim 14, said data storage system being a Compact Disc system, a Digital Video Disc system, or a Blu-ray system.

16. A camera system having an optical path and comprising a polarization independent phase modulator (1802; 1902) according to claim 1 arranged along said optical path.
